(19) United States
(12) Patent Application Publication
(10) Pub. No.: US 2012/0284551 A1
(43) Pub. Date: Nov. 8, 2012

(54) DEEP STANDBY METHOD AND DEVICE FOR EMBEDDED SYSTEM

(76) Inventors: Junhua Zhao, Guangzhou (CN); Ping Xu, Guangzhou (CN); Jianhua Luo, Guangzhou (CN); Norman Shengfa Hu, Guangzhou (CN)

(21) Appl. No.: 13/512,076

(22) PCT Filed: Feb. 17, 2010
(86) PCT No.: PCT/CN10/00213

§ 371 Date: May 25, 2012

(30) Foreign Application Priority Data
Nov. 25, 2009 (CN) 200910194147.8

(51) Int. Cl. G06F 1/32

(52) U.S. Cl. 713/323

(57) ABSTRACT

A deep standby method and device for and embedded system is disclosed, wherein the method mainly includes: a selecting step for selecting an available data swap block from the data swap area of a non-volatile memory as a deep standby block; a writing step for writing the current system data and state of the CPU into the deep standby block, and writing a deep standby flag into the deep standby block; and a shutting down step for making the system off to fall into a deep standby.

### FIELD OF THE INVENTION

The invention relates to a method and a device for switching a system into standby, and particularly to a method and a device for switching an embedded system into deep standby.

### BACKGROUND OF THE INVENTION

At present, the use of embedded mobile devices becomes more and more popular, such devices are generally battery-powered, and therefore one of the most important features thereof is the demand for low power consumption. In order to save power, the embedded mobile devices often need to switch into a standby mode. The standby mode refers to: storing the state and data of the running programs into a special non-volatile memory; and when the system switches to this mode, cutting off the power supply of all parts except for the memory. Since the memory maintains the system data based on the electricity, the system can be recovered to the state before standby when waking up. This is the most widely used standby technology adopted by the existing embedded mobile devices.

The existing embedded mobile device cannot automatically return to the previous interface when being powered on again after shutting down. However, the standby technology can make the system return to the previous interface, which looks like shutdown. However, the power supply is not cut off actually, and some devices, such as memory, are still powered on. In the case of the standby mode, there exists not only continuous resource consumption but also a certain amount of power consumption and equipment wear. In this way, after a long time without charge, system interruption and data loss will occur to the embedded mobile devices due to lack of power. In addition, if an accident shutdown occurs during the standby mode, information in the memory will be discarded, and thus all the working result and the usage state retained before standby is lost. Actually, in the standby mode some major equipment, such as the memory, will be powered to save the current state of the system, so as to achieve the purpose of reducing a part of power consumption, which is suitable for the case that the equipments are not used for a short period of time. However, when being shutdown, the information in the memory will be lost, which will bring inconvenience in operations. Therefore, a new energy saving, safe and reliable method is needed to resolve such problems.

### SUMMARY OF THE INVENTION

An object of the invention is to provide a deep standby method and device adapted to an embedded system and a mobile equipment thereof, which can make the equipment automatically return to the previous interface when the equipment is powered on again after shutdown, so as to greatly improve the speed of starting the system and help to extend the useful life of the related hardware and memory. To achieve the above object, the technical solution of the invention is as follows.

According to a first aspect of an embodiment of the invention, there is provided a deep standby method for an embedded system, including: a selecting step for selecting an available data swap block from a data swap area of a non-volatile memory as a deep standby block; a writing step for writing the current system data and CPU state into the deep standby block and writing a deep standby flag into the deep standby block; and a shutting down step for powering off the system to fall into deep standby.

According to a second aspect of the embodiment of the invention, there is provided a device for switching an embedded system into deep standby including: a selecting unit, configured to select an available data swap block from a data swap area of a non-volatile memory as a deep standby block; a writing unit, configured to write the current system data and CPU state into the deep standby block, and write a deep standby flag into the deep standby block; and a shutting down unit, configured to make the system power off to fall into a deep standby.

According to a third aspect of the embodiment of the invention, there is provided an embedded system including the device according to the second aspect of the embodiment of the invention.

Compared with the prior art, the method and device according to the embodiment of the invention have the following advantages:

(1) There is no difference between the deep standby mode and the actual shutdown, and thus the standby power consumption can be greatly reduced. In addition, when recovered from the deep standby mode, the system only needs to load the content stored in a flash memory (such as NandFlash) into the internal memory and perform a small amount of necessary initialization operation. Due to utilize an effective mechanism for selecting and searching the data switch block during data saving and recovering processes, the startup speed can be greatly improved. The ordinary startup time is about 2˜3 s; while according to the method of the embodiment of the invention, taking the read speed of 7 M/s of NandFlash as example to calculate, the time required for loading 192K memory data is about 30 ms, and considering the hardware initialization time, the startup time can be controlled in less than 100 ms, which greatly improves the startup speed;

(2) By using a standby block selecting and searching mechanism with redundancy and checking function according to the method of the embodiment of the invention, security, reliability and higher search efficiency of the deep standby mode can be ensured. Also, in the deep standby Mode, any additional erasing and writing operations is not made to the deep standby Block which is fully integrated with the original system, so as to achieve the purpose of NandFlash uniform wear and prolongs the useful life of the non-volatile memory, such as NandFlash, used in the embedded system as much as possible;

(3) The method and device according to the embodiment of the invention can make the embedded device recovery data directly from the NandFlash in the next power on, so as to recover to the last working state, and thus effectively avoid the loss of the work outcome;

(4) In the deep standby mode, only cnt+1 pages in total are required to save data, which can adequately utilize the swap block with empty pages not less than cnt+1;

(5) The method and device according to the embodiment of the invention writes a flag into the spare area of a page, which can improve the read efficiency of the system and further shorten the startup time.

### BRIEF DESCRIPTION OF THE DRAWINGS

FIG. 1 is a schematic flowchart of a deep standby method for an embedded system according to an embodiment of the invention;

FIG. 2 is an implementation logic block diagram of a deep standby method for an embedded system according to an embodiment of the invention;

FIG. 3 is a flowchart of the system saving of a deep standby method for an embedded system according to an embodiment of the invention;

FIG. 4 is a flowchart of the system recovering in a deep standby method for an embedded system according to an embodiment of the invention;

FIG. 5 is a schematic diagram of selecting the deep standby block of a deep standby method for an embedded system according to an embodiment of the invention;

FIG. 6 is a page data distribution diagram of a deep standby block of a deep standby method for an embedded system according to an embodiment of the invention;

FIG. 7 is a flowchart of the hardware initialization of a deep standby method for an embedded system according to an embodiment of the invention;

FIG. 8 is a schematic block diagram of a device for switching an embedded system into deep standby according to an embodiment of the invention; and

FIG. 9 is a schematic block diagram of a device for switching an embedded system into deep standby according to another embodiment of the invention.

### DETAILED DESCRIPTION OF THE INVENTION

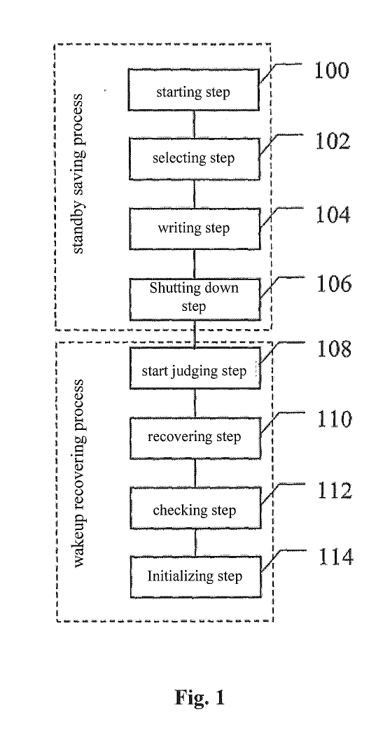

As shown in FIG. 1, a schematic flowchart of a deep standby method for an embedded system according to an embodiment of the invention is shown, which mainly includes: a selecting step 102, a writing step 104 and a shutting down step 106. In other embodiments, the method further optionally includes: a starting step 100, a startup judging step 108, a recovering step 110, a checking step 112, and/or an initializing step 114.

The method according to the embodiment can be generally divided into two processes, i.e. a standby saving process and a wake-up recovering process, as shown in FIG. 1. Steps involved in the two processes will be illustrated specifically hereinafter.

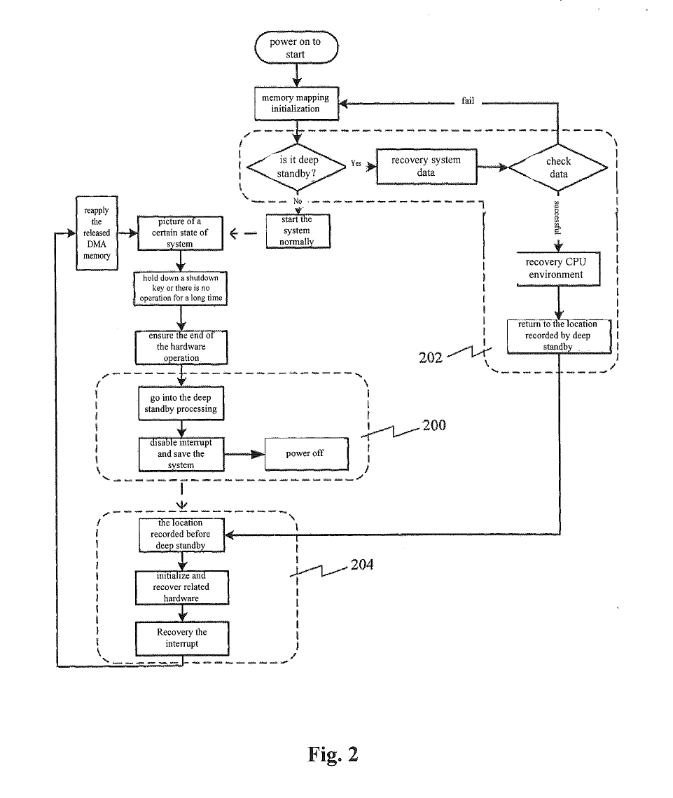

FIG. 2 shows a logic block diagram of implementing a deep standby method for an embedded system according to an embodiment of the invention. The implementation of the method according to the embodiment is divided into three processes: saving system data and CPU state (label 200 in Figure), recovering system data and CPU state (label 202 in Figure), and initializing related hardware (label 204 in Figure).

The system is a micro-memory system with physical memory of only 192K. The addresses are mapped into an address space of 2M by the software. There is 32K memory-resident code in the 2M address space, which is loaded into the first 32K space of the physical memory. The subsequent address space data and code are loaded into the last 160K space of the actual physical memory though a memory swap mechanism. The memory swap mechanism can load code or data required during the run time into the physical memory, and invalidate data in the memory according to a certain strategy. If the invalidated object is data and the data has been modified, the data will be written back to the NandFlash. The entire process of the deep standby method according to the embodiment is: under a certain state during normal operation of the system, detecting whether the user holds down a PLAY key to perform a shutdown operation or whether no operation is operated for a long time; if so, after the operations of hardware, such as a flash memory, is ended, saving system data and CPU state and then making the system power off to fall into the deep standby mode. When needing to wake up, the system is powered on to startup, recovers the system data and CPU state, performs the related data check, and returns to the interface or progress before the deep standby mode after the initialization of related hardware.

In the embodiment, data and scene environment of the running program are saved in NandFlash (which is a kind of flash memory, belongs to a non-volatile storage medium and is similar to a hard disk). However, other non-volatile memory can also be used, and after power off, the system switches into a deep standby mode. In the deep standby mode, both the NandFlash and the memory do not need to be powered, so the power consumption can be reduced greatly which can achieve the same effect as the case of power off During power on and startup again, the memory data and scene environment can be recovered directly from the NandFlash, the system can return to the working state retained at the last time, thus effectively avoiding the loss of work outcome.

In order that the system can accurately return to the state before standby at the power-up recovery, in the deep standby mode, all global variables needs to be saved when system saving is performed, these global variables are uniformly stored in the resident area of RAM (i.e., memory), which are commonly known as RAM resident area data. The RAM resident area data usually has a size of only about 4 KB, therefore one NandFlash block (the NandFlash is composed of many blocks, and a block is composed of the certain number of pages) is enough to save the RAM resident area data. Therefore, it is possible to select a block from the swap area to save the RAM resident area data and a special flag. In the method, this block is called as Deep Standby Block or Standby Block, and is referred to as Standby Block hereinafter. Before the system switches into the deep standby mode, the data in the memory and the scene environment are all written back to the NandFlash, also a serial number value and a deep standby flag are written on the NandFlash, and then the system is powered off directly. When needing to wake up, the system is powered on directly to start up. When the valid deep standby flag is detected on the NandFlash, both the contents of the entire memory and the scene environment can be recovered from the NandFlash, and related hardware is initialized. If no valid deep standby flag is detected, the system is started normally.

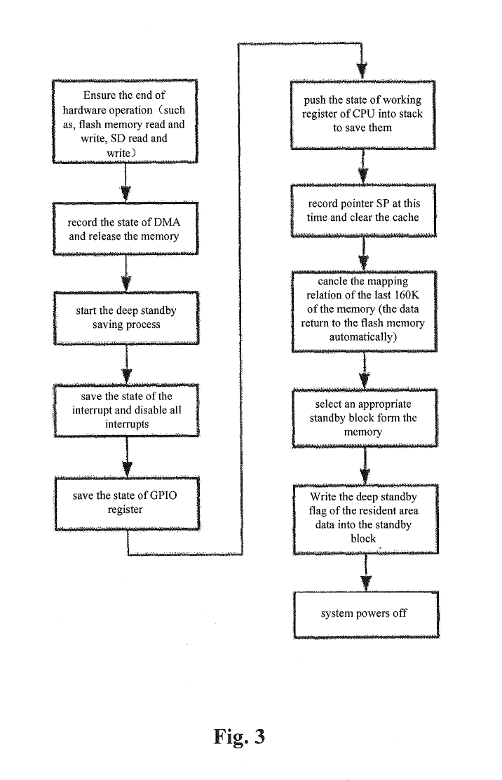

FIG. 3 shows a flowchart of system saving of a deep standby method for an embedded system according to an embodiment. Before performing the system saving, firstly it should to ensure the end of hardware operations, such as DMA or nand reading and writing. After the recording system is stable, the system switches into a system saving process which includes the following detailed operation:

1. saving the DMA (refers to continuous memory accessing) memory state and the state of all interrupts, and then Disabling interrupt.

2. Turning off the related hardware such as a display and a SD card; and recording the state of GPIO (i.e., General Purpose Input/Output) register.

3. Pushing CPU registers into stack for saving; and then recording the pointer of the SP (i.e., Stack Register); invalidating the cache area data to prepare for the release of the mapping relation of the last 160 KB memory of RAM.

4. Automatically writing the modified data page back to the swap area of NandFlash by using the previous memory mapping mechanism, and releasing the mapping relation of the last 160 KB non-memory-resident area data of RAM.

5. Selecting an appropriate standby block to write the memory-resident area data, the serial number value, data check and a deep standby flag into the standby block.

6. Sending a command via a specified GPIO to power off the system.

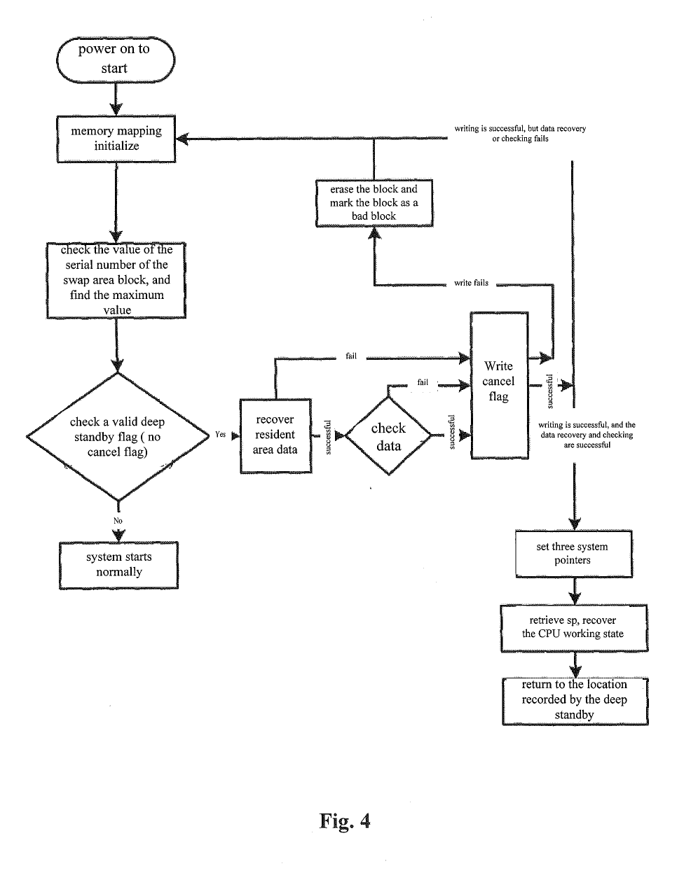

FIG. 4 is a flowchart of the system recovering of a deep standby method for an embedded system according to an embodiment. The system recovering is mainly used to implement the standby block searching and the recovery of RAM resident area data and system CPU environment. As shown, after being powered on and performing the initialization of MMU and remap (the memory mapping management section), the system searches a standby block in the swap area of the Nandflash, if no standby block is searched, the system is started normally. If a standby block is searched, the system RAM resident area data is recovered and checked. If the data recovery and check are successful, the recovery of the CPU scene environment is performed so as to return to the state before the deep standby mode; if the data recovery or check is unsuccessful, the system is rebooted to make a normal start.

The existence of the standby block will bring new problems, i.e. in the deep standby mode, there may be two additional erasing and writing operations on the standby block; one occurs before writing the resident area data and the special flags, one is erasing the flag after the recovery of the system. Over many times, this will result in serious consequences of NandFlash wear nonuniformity, and thus greatly reducing the useful life of NandFlash. To further resolve this problem so as to reach the purpose of NandFlash wear uniformity and ensure the safety and reliability of the system, a standby block selecting and searching mechanism with redundancy and checking functions is established. Because each block in the flash memory can be erased for only a certain number of times, one of the blocks is broken firstly if it is erased too frequently, which will affect the life of the whole flash memory. Thus, it needs to maintain the erasing and writing uniformity, i.e. wear uniformity.

In order to achieve wear uniformity, a value of the counter (count serial number) is set for searching the standby block, the value of the counter is the accumulated value of the number of the used swap blocks, i.e. the serial number value of the swap block, which is stored in the last third page of each swap block. Each time the swap block is used, the counter adds 1 automatically and the value of the counter is saved. Thus, the block with the maximum value of two counters is most likely to be the standby block. Furthermore, during the process of saving the RAM resident area data by the system, the unexpected shutdown may occur. In order to prevent the resulting unpredictable consequences and ensure the integrity of the RAM resident area data, the deep standby flag is written until the system saves the last page (i.e., the last second page of the standby block) of the RAM resident area data. In addition, the last page of the standby block is reserved, which will be written into a cancel (standby block canceled) flag after the system is recovered from the deep standby, so as to avoid additional erase on the NandFlash effectively.

The size of the RAM resident area data is fixed. Assuming that it totally has cnt pages, the start page of saving the RAM resident area data is the last cnt+1^{th} page. Also, assuming that the serial number value of the current swap block is n−1, and the number of the swap reservation blocks is m. Therefore, the selecting process for the deep standby block during the system saving process adopts the following standby block selecting and redundancy process:

Firstly, the system needs to select an appropriate standby block in the data swap area of the flash memory to save the RAM resident area data and a special flag. The step for selecting an appropriate standby block is: inspecting the number of the remaining pages of the current swap block, if the number is not less than cnt+1, the current swap block can be used as the standby block, otherwise, the next valid block is inspected until the appropriate standby block is selected.

The RAM resident area data is saved from the last cnt+1^{th} page of the standby block, and the total number of the pages is cnt. Also, the serial number value of the counter is written in the last third page of the standby block, and the deep standby flag is written in the last second page. If the writing fails, the block is marked as a bad block, and the valid data of this block is transferred to the next block.

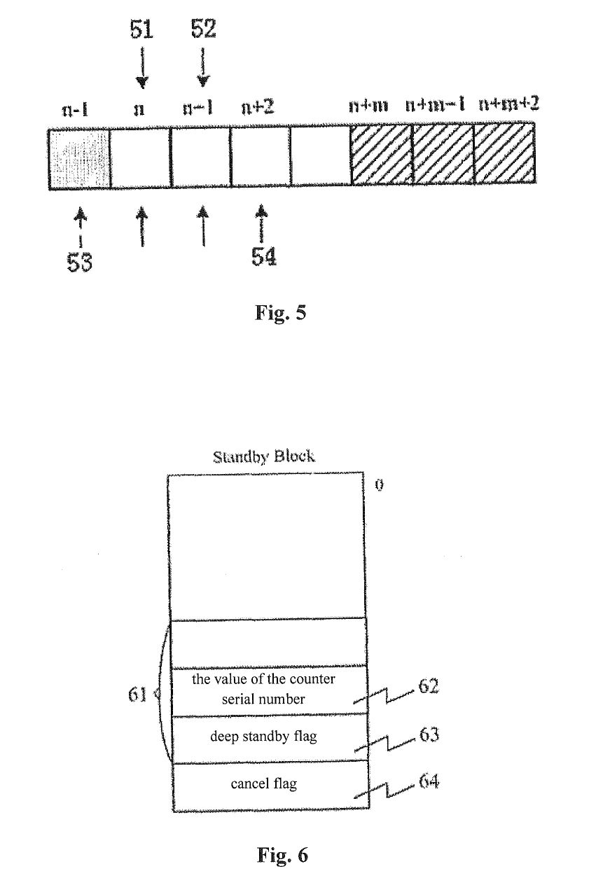

Meanwhile, in order to ensure the reliability of saving the RAM resident area data, two standby blocks can be provided, i.e. the redundancy process: as shown in FIG. 5, one is a main deep standby block 51, one is a backup deep standby block 52. 53 represents a data swap block which is already filled with data, 54 represents a new unwritten data swap block. The backup standby block is a valid block next to the main standby block, when an error occurs during writing the backup standby block, it only needs to reapply to select a backup standby block. In this way, during the recovery of the system, if an error occurs when reading the main standby block, the data of the backup standby block can be further read.

Note that in the case that the number of the remaining pages of the original swap block is less than cnt+1 and there is no bad block, except for the two standby block for saving the system data, the original swap block has been incremented for one, so actually the swap block has been incremented for three times in total. Therefore, in order to maintain the equalization of the swap reservation block, it should erase three blocks in total, so as to maintain the total number of the swap blocks unchanged.

In order to further improve the searching and reading efficiency during the searching process, in the planning of the standby block, the page data distribution of the standby block is shown in FIG. 6: 61 represents the system resident area data with a total cnt pages, where the serial number value of the counter is placed in the last third page (label 62 in Figure), the deep standby flag is placed in the last second page (label 63 in Figure), and the Cancel flag is placed in the last page (label 64 in Figure). The three special flags are all placed in the spare area of respective pages, so as to take full advantages of the page space of the NandFlash and improve the read speed.

Therefore, in the process of system recovery, the standby block can be searched by only searching the maximum of counter and then making judgment according to the flag. The specific standby block searching step is as follows:

1. Searching the maximum of the counter: since the value of the counter is an array of an ordered numerical value, a binary search algorithm is utilized. The numeric value of the spare in the last third page of the swap block is read; if the numeric value is 0xffffffff, it indicates that the maximum value of counter is located before this block. According to these rules, the maximum value of counter can be found quickly.

2. Judging the standby block: respectively reading flags in the spare areas of the last and last second pages of the block with the maximum value of the counter, if there is a deep standby flag and no cancel flag, the deep standby flag is valid, and this block is the backup standby block. According to this, judging the block with the second maximum value of the counter to find the main standby block.

In addition, in view of safety and reliability, in order to ensure the correctness of the recovered data, the legitimacy and the data-sum value of the standby block should be checked after the data in the standby block is recovered.

1. Checking the legitimacy of the standby block: recording, by a global variable, the location of the standby block before the system saving; after the RAM resident area data has been recovered, checking whether the location of the currently found standby block is consistent with the global variable, if not, it is considered that the deep standby flag is invalid and the standby block is illegal.

2. Checking the sum of the recovered data: calculating a checksum value to the global variable when the system saves the RAM resident area; calculating another checksum value of the data after the system has recovered the resident area data, in which the calculation method of the two checksum values is adding the data in four bytes to calculate the sum; comparing the checksum value of the system recovered data with the global variable, if not consistent, it is illustrated that the data recovery is invalid.

3. Writing a cancel flag in the spare area of the last page of the block, if there exists inconsistency anywhere above, the system restarts, so as to ensure the legitimacy of the standby block and prevent the unpredictable consequences caused by the occasional occurrence of the deep standby flag in a non-standby block. If the write of the cancel flag fails, the block is marked as a bad block and the system reboots.

With the above standby block selecting and searching mechanism, reliable data saving and higher searching efficiency can be provided to ensure that the erasing and writing times of each block in the NandFlash will not be increased additionally, thus prolonging the useful time of the NandFlash as much as possible. At the same time, it can be seen from the above mechanism that the standby block is selected according to the original swap mechanism of the system, which does not destroy the data written back to the Nandflash by the system and can also rely on the original Nandflash wear uniform mechanism of the swap area. Meanwhile, in order to take full advantage of the erased block and prolong the life of NandFlash as much as possible, it will firstly judges the number of the remaining pages of the current swap block before selecting a standby block, if the number is not less than cnt +1, the current swap block is selected as the standby block.

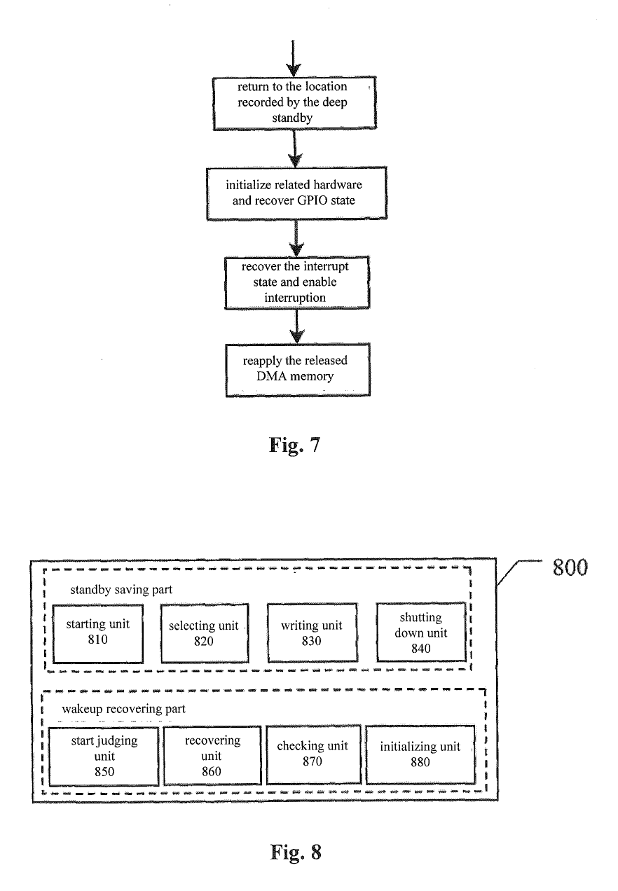

After the system data is recovered, the initialization and recovery operations of the necessary hardware module are performed. FIG. 7 shows the hardware initialization process: when the system returns from the deep standby mode, the initialization and recovery of the related hardware registers are performed. The main operations include: enabling the memory access counting to interrupt; initializing the memory; initializing a phase-locked loop module; initializing AD and DA (analog/digital interface and digital/analog interface) modules; initializing GPIO and recovering the register state; initializing a display module; initializing a SD memory module; initializing a timer module; initializing a FM (radio) module; resetting the frequency management; recovering all interrupt status, and enabling the interrupt; reapplying the released DMA memory and recovering the mapping between the DMA virtual address and the physical address. Finally, the system is recovered to the system state before the deep standby mode.

It can be seen that, there is no need to re-erase the reserved block after recovery from the deep standby mode, so as to avoid the repeated erasure of the first several blocks of the swap area during normal power up, therefore improving the original NandFlash wear uniform mechanism of the swap area.

Based on the standby block selecting and searching mechanism with redundancy and checking functions, system security and reliability and high search efficiency of the deep standby mode can be ensured well. Also, there is no additional erase to the standby block in the deep standby mode, therefore the deep standby mode is fully integrated with the original system to achieve the purpose of the NandFlash uniform wear. Moreover, the saving data in the deep standby mode only needs cnt+1 (page 3 in the solution) pages in total, which takes full advantages of the swap block having empty pages not less than cnt+1, so as to prolong the useful life of the Nandflash as much as possible. In addition, by writing a flag into the spare area of a page, the read efficiency can be improved, and the startup time can be shortened.

In summary, when the system switches into the deep standby mode, the data in the memory and the scene environment are all written back to the Nandflash, a serial number value and a deep standby flag are also written to the Nandflash, then and the system is powered off directly. When needing to wake up, the system is directly powered on to start. When a valid deep standby flag is detected from the Nandflash, the content of the overall memory and the scene environment are recovered from the Nandflash, and the corresponding hardware is initialized. If no valid deep standby flag is detected, the system starts normally.

Therefore, there is no difference between the deep standby mode and the actual power off, so as to greatly reduce the standby consumption. Furthermore, when recovered from the deep standby mode, the system only needs to load the content stored in the Nandflash into the memory and perform a small amount of necessary initialization operation, and thus the start speed will be improved greatly. If taking the read speed of 7 M/s of NandFlash as example to calculate, the time required for loading 192K memory data is about 30 ms, and in view of the hardware initialization time, the startup time can be controlled in less than 100 ms, which is much faster than the ordinary startup time of 2˜3 s.

FIG. 8 is a schematic diagram of a device 800 for switching an embedded system into deep standby according to an embodiment. The device 800 includes: a selecting unit 820, a writing unit 830, and a shutting down unit 840. In other embodiments, the device 800 can optionally include: a starting unit 810, a start judging unit 850, a recovering unit 860, a checking unit 870, and/or an initializing unit 880.

The units in the device 800 according to the embodiment can be generally divided into two parts: a standby saving part and a wake up recovering part, as shown in FIG. 8, in which:
a starting unit 810 is configured to perform step 100;
a selecting unit 820 is configured to perform step 102;
a writing unit 830 is configured to perform step 104;
a shutting down unit 840 is configured to perform step 106;
a start judging unit 850 is configured to perform step 108;
a recovering unit 850 is configured to perform step 110;
a checking unit 860 is configured to perform step 112; and
an initializing unit 870 is configured to perform step 114.

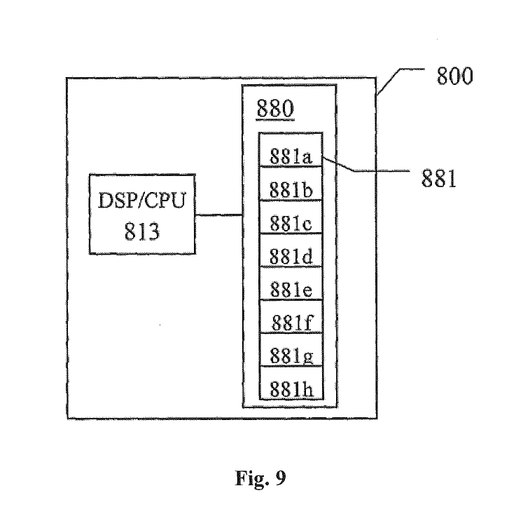

FIG. 9 is an embodiment of another device 800 for switching an embedded system into deep standby. The device 800 includes a processing unit 813, such as DSP or CPU. The processing unit 813 can be a single or multiple unit(s) to perform the different steps described. In addition, the device 800 also includes at least one computer program product 880 in the form of the non-volatile memory, such as EEPROM, flash memory or hard disk drive. The computer program product 880 includes a computer program 881, and the computer program 881 includes program codes which perform the steps shown in FIG. 1 during being run.

Specifically, the program codes in the computer program 881of the device 800 include: a starting module 881 configured to perform step 100, a selecting module 881b configured to perform step 102, a writing module 881c configured to perform step 104, a shutting down module 881d configured to perform step 106, a start judging 881e configured to perform step 108, a recovering module 881f configured to perform step 110, a checking module 881g configured to perform step 112, and an initializing module 881h configured to perform step 114. In other words, when running on the processing unit 813, the different modules 881a-881h respectively correspond to the units 810, 820, 830, 840, 850, 860, 870 and 880 shown in FIG. 8.

The device 800 for switching an embedded system into deep standby according to the above embodiments can be implemented in various embedded systems through software, hardware, firmware or any combination thereof. This implementation is easy for those skilled in the art, which will not be described in detail herein.

In addition, the deep standby method for an embedded systems according to the embodiment of the invention is verified by taking a digital electronic product as example, and the verification result is as follows:

(1) System Setting

The system is switched to the deep standby mode from any interface of the system setting; and after powering again, the system can return to the previous interface, and key operations are proper.

(2) Audio/Video Playing

The system is switched into the deep standby mode from a file selecting interface for audio/video playing; and after powering again, the system can return to the previous interface, and key operations are proper.

The system is switched into the deep standby mode from a file playing interface for audio/video playing; and after powering again, the system returns to the file selecting interface, the current selected file is the file played before standby, and key operations are proper. When pressing the play key, the system will switch into the plan saved before deep standby mode and continue to play.

(3) Recording

The system is switched into the deep standby mode when recording, and after powering again, the system returns to the recording interface, and key operations are proper.

(4) Audio Play

The system is switched into the deep standby mode when performing audio play, and after powering again, the system can return to the playing file interface, and key operations are proper. When pressing the play key, the system will switch the plan saved before deep standby mode and continue to play.

(5) Picture Browsing

The system is switched into the deep standby mode when browsing pictures, and after powering again, the system can return to the picture file selecting interface, the current selected file is the file browsed before deep standby, key operations are proper, and the browsing can be continued normally.

(6) e-Book

The system is switched into the deep standby mode when browsing the e-book, and after powering again, the system can return to the e-book selecting interface, the current selected file is the file browsed before deep standby, key operations are proper, and the browsing can be continued normally.

In view of the illustration of the above verified examples, in the deep standby method for an embedded system according to the embodiment of the invention, after the system switches into the deep standby mode, the power consumption of the embedded mobile device is greatly reduced, so as to achieve the same effect as the shutdown. After powering again, the state and scene environment saved previously can be automatically recovered, and the system can return to the interface before the deep standby mode, and can normally perform to the next operation. At the same time, the work outcome can be saved reliably and the start speed is improved. In actual verification, it is found that the restart speed is fast, which can be substantially in less than 100 ms.

Although the invention has been illustrated above through specific embodiments, the invention is not limited to these specific embodiments. Those skilled in the art should appreciate that various modifications, equivalent alternatives, changes and so on can be made to the invention, for example, one step or unit in the above embodiment is divided into two or more steps or units for implementation, or, the functions of two or more steps or units are integrated into one step or unit for implementation. However, these changes should fall within the scope of protection of the invention, as long as they do not departs from the spirit of the invention. In addition, terms used in the specification and claims of the application are just for illustration, without limitation. In addition, the “an embodiment” described above in many places are different embodiments; of course, the embodiments can also be combined in one embodiment in whole or in part.

1. A deep standby method for an embedded system, comprising:
a selecting step for selecting an available data swap block from a data swap area of a non-volatile memory as a deep standby block;
a writing step for writing current system data and CPU state into the deep standby block, and writing a deep standby flag into the deep standby block; and
a shutting down step for powering off the system to fall into deep standby.

2. The method according to claim 1, further comprising:
a recovering step for reading data in a valid deep standby block to recover the system data and CPU state when the system is powered on to start again and a deep standby flag is found after memory mapping initialization, and writing a cancel flag into the deep standby block.

3. The method according to claim 1, further comprising:
a starting step for switching the system into deep standby, when the user holds down a shutdown key during the system running or there is no operation in a predetermined period and after it is ensured that system hardware operation has ended.

4. The method according to claim 2, further comprising:
a start judging step for judging whether there is the valid deep standby flag when the system is powered on to start, if there is a valid deep standby flag, switching into the recovering step; else, starting normally.

5. The method according to claim 2, further comprising:
a checking step for checking whether the location of the found deep standby block is consistent with that of the deep standby block that is recorded by a global variable before writing data; if not consistent, the deep standby flag is invalid and the corresponding deep standby block is illegal, writing a cancel flag into a spare area of the last page of the block and restarting the system; and/or
checking whether the checksum calculated during saving data is consistent with that calculated after the system is recovered, if not consistent, the data recovery is invalid, writing a cancel flag into a spare area of the last page of the block and restarting the system.

6. The method according to claim 2, further comprising:
an initializing step for performing related hardware initialization, after the system data is recovered successful and the location before the system saving is returned, so as to return the system to the state before the deep standby mode.

7. The method according to claim 1, wherein in the selecting step, a current data swap block in which the number of remaining pages is not less than cnt+1 is selected as the deep standby block, wherein cnt is the number of the pages of the memory-resident area data.

8. The method according to claim 1, wherein in the selecting step, two deep standby blocks are selected for storing the current system data and CPU state, wherein one deep standby block is a main deep standby block, the other deep standby block is a backup deep standby block, and the backup deep standby block is a valid data swap block next to the main deep standby block.

9. The method according to claim 1, wherein in the writing step, writing the value of a counter serial number into the deep standby block, wherein the value of the counter serial number is automatically increased by one and saved each time the selected deep standby block is used.

10. The method according to claim 9, wherein in the recovering step, searching a data swap block having a maximum value of the counter serial number and determining the data swap block as a valid deep standby block after judging the data swap block has a deep block flag and no cancel flag.

11. The method according to claim 10, wherein a binary searching algorithm is utilized to search the maximum value of the counter serial number.

12. The method according to claim 9, wherein the deep standby flag, the value of the counter serial number and the cancel flag are respectively written into the spare areas of the last third page, the last second page and the last page of the deep standby block.

13. The method according to claim 1, wherein in the writing step, the deep standby flag is written into the deep standby block after the current system data and CPU state are written into the last page of the deep standby block.

14. The method according to claim 1, wherein when writing the current system data and CPU state, the last page of the deep standby block is reserved for writing a cancel flag.

15. A device for switching an embedded system into deep standby, comprising:
a selecting unit configured to select an available data swap block from a data swap block of a non-volatile memory as a deep standby block;
a writing unit configured to write current system data and CPU state into the deep standby block, and write a deep standby flag into the deep standby block; and
a shutting down unit configured to power off the system to fall into deep standby.

16. The device according to claim 15, further comprising:
a recovering unit configured to read data in a valid deep standby block to recover the system data and CPU data when the system is powered on to start again and a deep standby flag is found after memory mapping initialization, and write a cancel flag into the deep standby block.

17. The device according to claim 15, further comprising:
a starting unit configured to switch the system into deep standby when the user holds down a shutdown key during the system running or there is no operation in a predetermined period and after it is ensured that system hardware operation has ended.

18. The device according to claim 16, further comprising:
a start judging unit configured to judge whether there is a valid deep standby flag when the system is powered on to start, wherein if there is a valid deep standby flag, the recovering unit runs; else, the system starts normally.

19. The device according to claim 16, further comprising:
a checking unit configured to check whether the location of the found deep standby block is consistent with that of the deep standby block that is recorded by a global variable before writing data, if not consistent, the deep standby flag is invalid and the corresponding deep standby block is illegal, and the system restarts after writing a cancel flag into the spare area of the last page of the block; and/or
configured to check whether the checksum calculated during saving data is consistent with that calculated after the system is recovered, if no consistent, the data recovery is invalid, and the system restarts after a cancel flag is written into the spare area of the last page of the block.

20. The device according to claim 16, further comprising:
an initializing unit configured to perform related hardware initialization after the system data is recovered successfully and the location before the system saving is returned, so as to return the system to the state before the deep standby mode.

21. An embedded system, comprising a device for switching an
embedded system into deep standby, wherein the device comprising:
a selecting unit configured to select an available data swap block from a data swap block 5 of a non-volatile memory as a deep standby block;
a writing unit configured to write current system data and CPU state into the deep standby block, and write a deep standby flag into the deep standby block; and
a shutting down unit configured to power off the system to fall into deep standby.
